(19) United States
(12) Patent Application Publication
(10) Pub. No.: US 2012/0067903 A1
(43) Pub. Date: Mar. 22, 2012

(54) POT WITH A COVER-LIFTING MECHANISM

(75) Inventor: Kuei-Tang CHANG, Banchiau City (TW)

(73) Assignee: Tall & Stout Industrial Corp.

(21) Appl. No.: 12/883,254

(22) Filed: Sep. 16, 2010

(51) Int. Cl. A47J 36/00; B65D 51/00

(52) U.S. Cl. 220/573.1; 220/212

(57) ABSTRACT

A pot includes a pot body, an upper cover pivotally covering the pot body, and a cover-lifting mechanism connected between the pot body and the upper cover. The cover-lifting mechanism includes a piston rod. Both ends of the piston rod are pivotally connected to the pot body and the upper cover respectively. The piston rod extends corresponding to an angle between the upper cover and the pot body when the upper cover is lifted. With this arrangement, the user can lift the upper cover with a less force. Further, the upper cover can be prevented from covering the pot body suddenly to damage the components and electric circuits therein and to protect the user's finger from getting hurt if the user puts his/her finger on the upper edge of the pot body. Therefore, the present invention really improves the practicability and safety of a pot.

### BACKGROUND OF THE INVENTION

1. Field of the Invention

The present invention relates to a pot, in particular to a pot with a cover-lifting mechanism.

2. Description of Prior Art

With the advancement of science and technology, various novel household electronic appliances are developed in order to improve the convenience in our daily life. In addition to microwave ovens and toasting ovens, a hot air convection pot is developed, which includes a pot body, an upper oven, and an electric heating module. The interior of the pot body is formed with a chamber for accommodating food materials. The upper cover is pivotally connected to the pot body for selectively covering the pot body. The electric heating module is connected with the upper cover. The electric heating module is configured to generate high-temperature airflow and blow the hot airflow into the pot body. The convection of the hot airflow in the pot body is used to cook the food materials received therein.

It should be noted that the upper cover is pivotally connected to the rim of the pot body by means of a pivot. A user lifts the upper cover by one hand until the angle between the upper cover and the pot body exceeds 90 degrees where the edge of the upper cover abuts the rim of the pot body. At this position, the upper cover is lifted to a maximum angle which is referred to as a limit position hereinafter.

However, in practice, the above-mentioned hot air convection pot has the following problems. Since the upper cover is connected with the electric heating module, the weight of the whole upper cover is so large that the user has to exert a large force to lift the upper cover to the limit position. In other words, the user has to lift the heavy upper cover until the angle between the upper and the pot body exceeds 90 angles. As a result, such a cover-lifting action is a laborious job for some users with little strength. On the other hand, only when the upper cover has been lifted to the limit position can the user release his/her hand, otherwise the upper cover may cover the pot body again due to a moment generated by its gravity force with respect to the pivot.

On the other hand, when the upper cover is lifted to the limit position, since there is no locking mechanism between the upper cover and the pot body, the upper cover may suddenly cover the pot body if the user touches the upper cover accidentally to generate a moment for rotating the upper cover around the pivot to cover the pot body again. Such a sudden covering of the upper cover may make the components or electric circuits within the upper cover to suffer damage. If the user puts his/her finger on the upper edge of the pot body, the above-mentioned sudden covering of the upper cover may hurt the user's finger.

If such a hot air convection pot is provided with a cover-lifting mechanism, the user can lift the upper cover with a less force to a desired angle. Also, the user need not worry whether the upper cover would cover the pot body suddenly. Thus, such an arrangement is very convenient for the user.

### SUMMARY OF THE INVENTION

The present invention is to provide a pot with a cover-lifting mechanism, whereby the user can lift the upper cover with a less force to a desired angle, and the user need not worry whether the upper cover may cover the pot body suddenly.

The present invention provides a pot with a cover-lifting mechanism, including: a pot body; an upper cover pivotally covering the pot body; and a cover-lifting mechanism comprising a piston rod, both ends of the piston rod being pivotally connected to the pot body and the upper cover respectively, wherein the piston rod extends corresponding to an angle between the upper cover and the pot body when the upper cover is lifted.

The present invention is to provide a pot with a cover-lifting mechanism, whereby the user can lift the upper cover with a less force to a desired angle, and the user need not worry whether the upper cover may cover the pot body suddenly.

The present invention provides a cover-lifting mechanism for a pot, the pot comprising a pot body and an upper cover for pivotally covering the pot body, the cover-lifting mechanism comprising a piston rod, both ends of the piston rod being pivotally connected to the pot body and the upper cover respectively, wherein the piston rod extends corresponding to an angle between the upper cover and the pot body when the upper cover is lifted.

In comparison with prior art, the present invention has advantageous features as follows:

According to the present invention, a cover-lifting mechanism is provided between the upper cover and the pot body. The cover-lifting mechanism includes a piston rod. Both ends of the piston rods are pivotally connected to the pot body and the upper cover. The piston rod extends corresponding to an angle between the upper cover and the pot body when the upper cover is lifted. Thus, when the user lifts the upper cover from the pot body, the piston rod extends to lift the upper cover completely, whereby the user can lift the upper cover with a less force to a desired angle.

According to the present invention, a piston rod is provided between the upper cover and the pot body, and the piston rod extends to lift the upper cover from the pot body. Thus, the upper cover can be prevented from covering the pot body again by its gravity force because the extended piston rod continuously pushes the upper cover. If the user intends to cover the upper cover again, the user has to exert a force plus the weight of the upper cover to overcome the pushing moment of the piston rod. In this way, the upper cover can be prevented from covering the pot body suddenly to damage the components and electric circuits within the upper cover and to protect the user's finger from getting hurt if the user puts his/her finger on the upper edge of the pot body. Therefore, the present invention really improves the practicability and safety of a pot.

### BRIEF DESCRIPTION OF DRAWING

FIG. 1 is an assembled perspective view showing a pot of the present invention;

FIG. 2 is an exploded perspective view showing an upper cover and a cover-lifting mechanism of the present invention;

FIG. 3 is an exploded perspective view showing the pot of the present invention;

FIG. 4 is a partial side cross-sectional view of the present invention, showing the upper cover covering the pot body; and

FIG. 5 is a partial side cross-sectional view of the present invention, showing the upper cover being lifted from the pot body completely.

### DETAILED DESCRIPTION OF THE INVENTION

The detailed description and technical contents of the present invention will become apparent with the following detailed description accompanied with related drawings. It is noteworthy to point out that the drawings is provided for the illustration purpose only, but not intended for limiting the scope of the present invention.

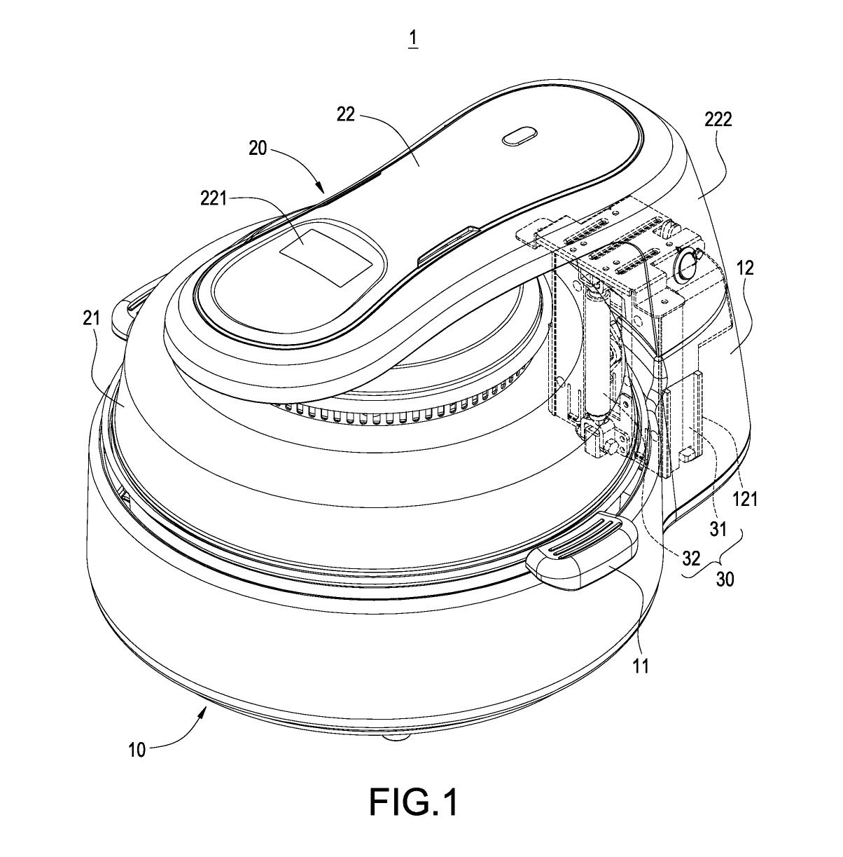

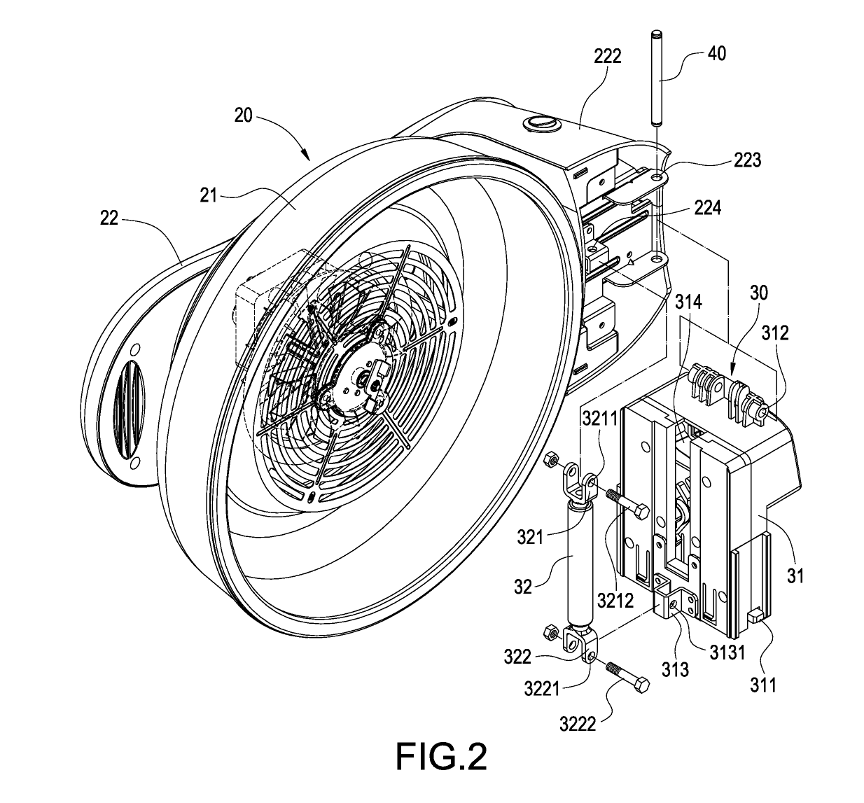

Please refer to FIGS. 1 and 2. The present invention provides a pot with a cover-lifting mechanism. As shown in FIG. 1, the pot 1 includes a pot body 10, an upper cover 20 and a cover-lifting mechanism 30.

The rim of the pot body 10 is formed with two opposite tabs 11. The user holds the two tabs to carry the pot 1. One side surface of the pot body 10 is formed with an assembling portion 12 in which a trough 121 is provided. An inner pot 13 is selectively put in the pot body 10. The inner bottom surface of the inner pot 13 is formed with a rotating shaft 131. The rotating shaft 131 is connected to a stirring element 132 for stirring food materials received in the inner pot 13.

The upper cover 20 is configured to pivotally cover the pot body 10. As shown in FIG. 1, the upper cover 20 includes a cover plate 21 covering the rim of the pot body 10, and an operating portion 22 connected to the cover plate 21. The surface of the operating portion 22 is provided with a display 221 and control keys (not shown). The display 221 is configured to display the heating temperature, the heating period and the heating mode and other information of the pot 1. The user utilizes the control keys to adjust the heating temperature, the heating period and the heating mode of the pot 1.

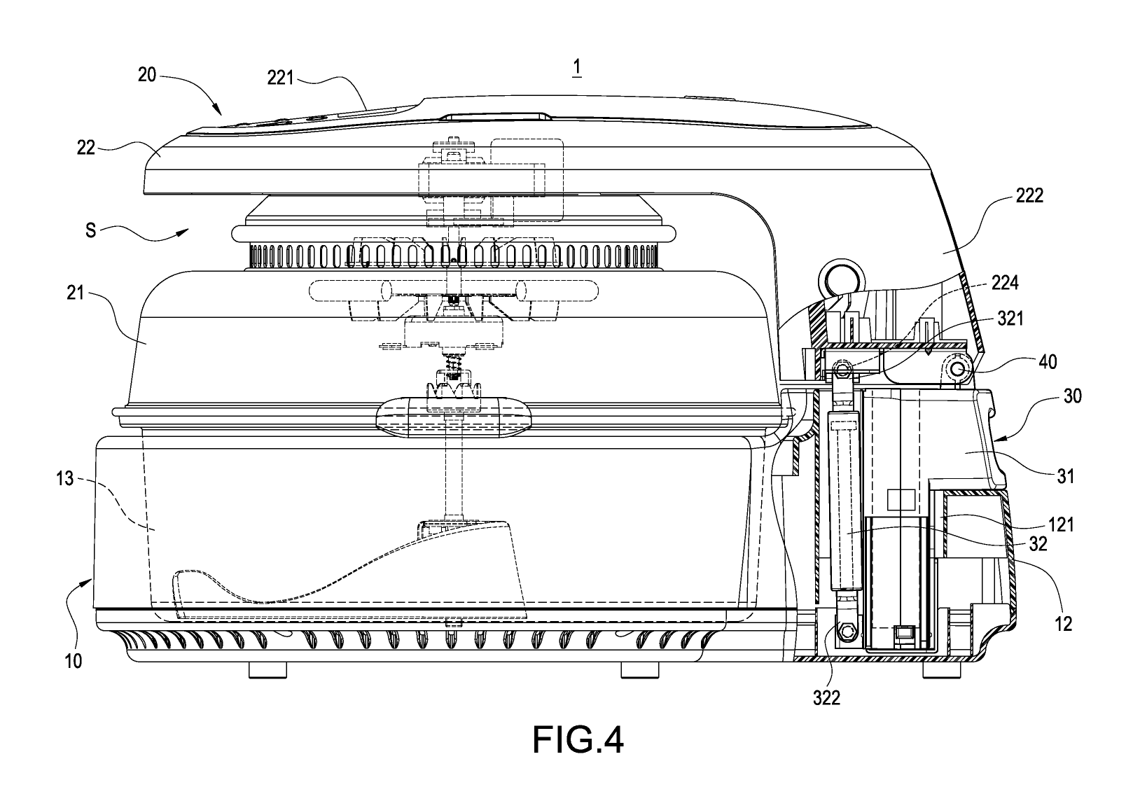

As shown in FIG. 4, a cover-lifting space S is formed between the front end of the operating portion 22 and the top end of the cover plate 21. The user can lift the operating portion 22 via the cover-lifting space S and then lift the upper cover 20 completely. The interior of the upper cover 20 is provided with a motor, a transmission shaft, a heat-dissipating impeller, a heater and an air-blowing impeller. The motor drives the transmission shat, the heat-dissipating impeller and the air-blowing impeller to rotate. The heat-dissipating impeller dissipates the heat generated by the motor to the outside via heat-dissipating holes formed on the surface of the cover plate. The air-blowing impeller blows the hot airflow generated by the heater into the pot body 10 for cooking the food materials in the pot body 10. Since the motor, the transmission shaft, the heat-dissipating impeller, the heater and the air-blowing impeller are not the technical characteristics of the present invention, the description relating thereto will be omitted for simplicity. The other end of the operating portion is bent to form a connecting section 222.

The bottom surface of the connecting section is formed with a pair of first through-holes 223 and a pair of second through-holes 224. The connecting section 222 is used to connect the cover-lifting mechanism of the present invention.

The cover-lifting mechanism 30 comprises a pivoting portion 31 engaged with the trough 121 of the pot body 10 and a piston rod 32 connected to the pivoting portion 31. As shown in FIG. 2, both sides of the bottom surface of the pivoting portion 31 are formed with a locking hook 311 respectively. The locking hook 311 is configured to be engaged in the trough 121. The top surface of the pivoting portion 31 is formed with a pivotal hole 312. A pivot 40 penetrates the pivotal hole 312 and the first through-holes 223, whereby the upper cover 20 can be pivotally connected to the pivoting portion 31.

One end of the piston rod 32 is pivotally connected to the bottom surface of the pivoting portion 31. The other end of the piston rod 32 is pivotally connected to the second through-holes 224 of the connecting portion 222 of the upper cover 20. More specifically, as shown in FIG. 2, both ends of the piston rod 32 are formed with a U-shaped connecting piece 321, 322 respectively. The upper connecting piece 321 is provided with a pair of penetration holes 3211, while the lower connecting piece 322 is provided with a pair of penetration holes 3221. With a bolt 3212 penetrating the penetration hole 3211 and the second through-holes 224, the upper connecting piece 321 of the piston rod 32 can be pivotally connected to the connecting portion 222 of the upper cover 20. Similarly, the bottom surface of the pivoting portion 31 is formed with a connecting tab 313. The connecting tab 313 also has a pair of third through-holes 3131. With a bolt 3222 penetrating the third through-holes 3131 and the penetration hole 3221, the lower connecting piece 322 of the piston rod 32 can be pivotally connected to the pivoting portion 31.

It should be noted that a notch 314 is formed on a surface of the pivoting portion 31 adjacent to the piston rod 32. The notch 314 is configured to allow the piston rod 32 to extend obliquely through the pivoting portion 31. Further, a distance is provided between the piston rod 32 and the pivot 40. The piston rod 32 is positioned to be closer to the rim of the pot body 10 than the pivot 40. With this arrangement, the piston rod 32 extends to generate a cover-lifting moment with respect to the pivot 40, thereby pushing and lifting the upper cover 20 completely.

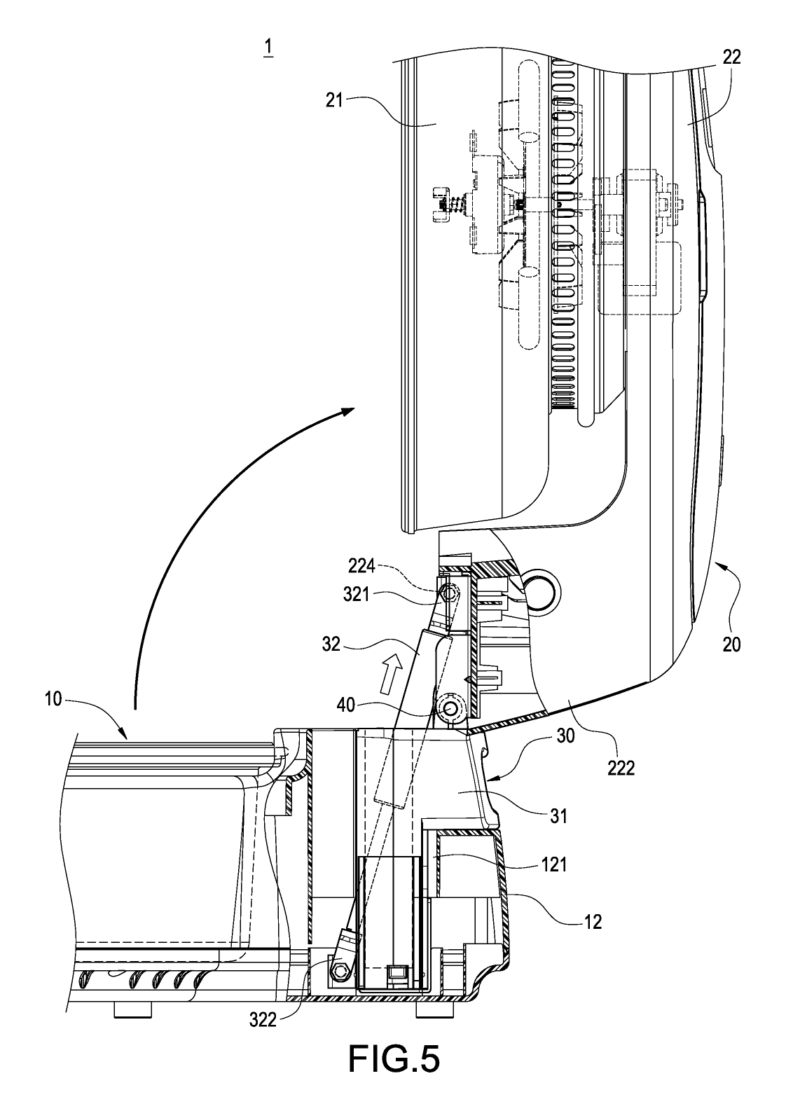

Next, with reference to FIGS. 4 and 5, the operating principle of the present invention will be described.

As shown in FIG. 4, when the upper cover 20 covers the pot body 10, the piston rod 32 is in a retracted state. At this time, a counterclockwise covering moment generated by the weight of the upper cover 20 with respect to the pivot 40 is larger than a clockwise lifting moment generated by the extension of the piston rod 32 with respect to the pivot 40. Thus, the upper cover 20 cannot be lifted by the piston rod 32 only, so that the user has to exert a force to lift the upper cover 20.

As shown in FIG. 5, when the user lifts the upper cover 20 to a certain angle, the upper connecting piece 321 of the piston rod 32 is pivotally connected to the second through-holes 224 of the connecting portion 221, so that the piston rod 32 can extend corresponding to the angle between the lifted upper cover 20 and the pot body 10. When the angle between the lifted upper cover 20 and the pot body 10 increases, the counterclockwise covering moment generated by the weight of the upper cover 20 with respect to the pivot 40 decreases while the piston rod 32 gradually extends. The present invention is characterized in that the piston rod extends corresponding to the angle between the lifted upper cover 20 and the pot body 10. This is because the cover-lifting moment generated by the extension of the piston rod 32 can be balanced with the covering moment generated by the weight of the upper cover 20 with respect to the pivot at an angle smaller than 9 degrees. In other words, when the user lifts the upper cover 20 to a desired angle smaller than 90 degrees, the piston rod 32 can extends to a proper length to hold the upper cover 20 to the desired angle. On the other hand, with the increase of the angle between the lifted upper cover 20 and the pot body 10, the magnitude of the force exerted by the user decreases accordingly. This is because the covering moment generated by the upper cover 20 decreases when the angle between the lifted upper cover 20 and the pot body 10 approaches 90 degrees. Thus, by means of the cover-lifting mechanism of the present invention, the upper cover 20 can be lifted by a less force to a desired angle.

It should be further noted that the lifting direction of the upper cover 20 is indicated by the arrow in FIG. 5. The angle between the lifted upper cover 20 and the pot body 10 can be easily adjusted to any desired angle within 90 degrees. After the upper cover 20 is lifted completely, the edge of the connecting portion 221 of the upper cover 20 abuts against the side of the pivoting portion 31, so that the upper cover 20 cannot be further lifted clockwise. On the other hand, since the piston rod 32 obliquely supports the upper cover 20, the piston rod 32 generates a clockwise cover-lifting moment with respect to the pivot 40, so that the upper cover 20 cannot cover the pot body 10 again by itself. The user has to exert a force plus the weight of the upper cover 20 to overcome the clockwise cover-lifting moment. In this way, the upper cover 20 can be prevented from covering the pot body 10 suddenly to damage the components and electric circuits within the upper cover and to protect the user's finger from getting hurt if the user puts his/her finger on the upper edge of the pot body 10. Therefore, the present invention really improves the practicability and safety of a pot.

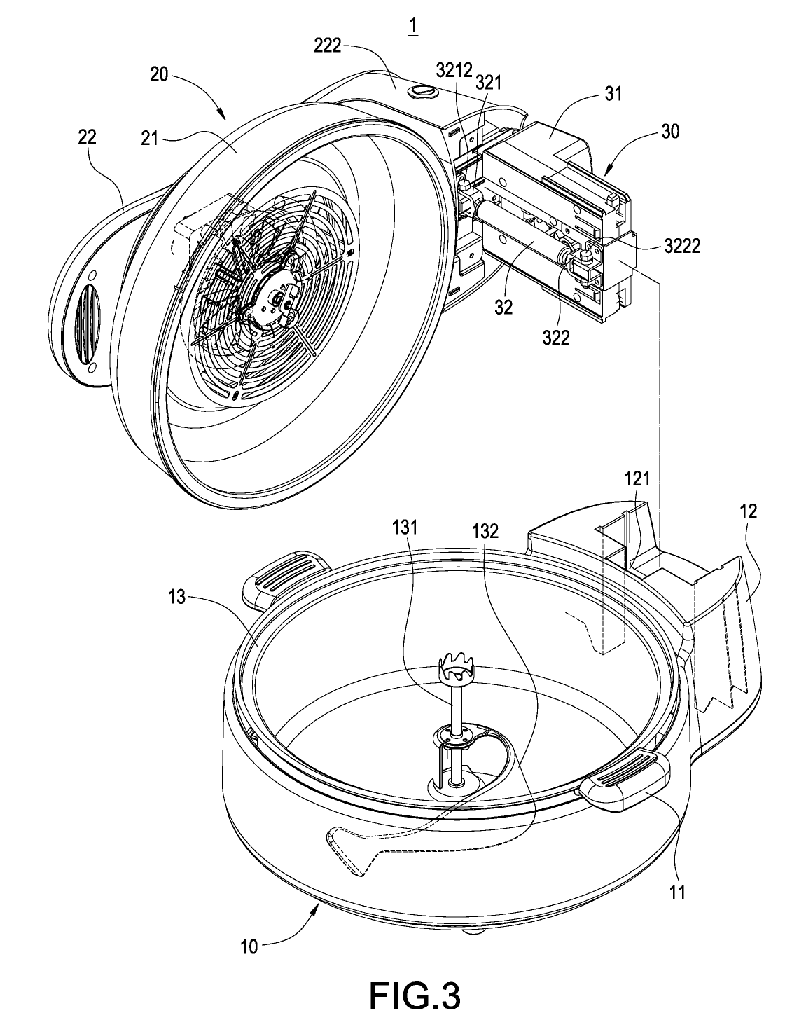

It should be noted that, although the pivoting portion 31 and the piston rod 32 of the cover-lifting mechanism 30 are detachably engaged in the trough 121 of the pot body 10 as shown in FIG. 3, the pivoting portion 31 and the piston rod 32 may be fixed into the trough 121 as long as the upper cover 20 is pivotally connected to the pot body 10, and both ends of the piston rod 32 are pivotally connected to the upper cover 20 and the pot body 10 respectively.

It should be noted that the pot 1 shown in FIG. 3 is a hot air convection pot, but the cover-lifting mechanism 30 can be further applied to an electric pot, a pressure pot or the like.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A pot including:
a pot body;
an upper cover pivotally covering the pot body; and
a cover-lifting mechanism comprising a piston rod, both ends of the piston rod being pivotally connected to the pot body and the upper cover respectively, wherein the piston rod extends corresponding to an angle between the upper cover and the pot body when the upper cover is lifted.

2. The pot according to claim 1, wherein one side surface of the pot body is formed with an assembling portion, and a trough is provided in the assembling portion for allowing the cover-lifting mechanism to be inserted therein.

3. The pot according to claim 2, wherein the upper cover comprises a cover plate covering a rim of the pot body and an operating portion connected to the cover plate, and a cover-lifting space is formed between a front end of the operating portion and a top end of the cover plate.

4. The pot according to claim 3, wherein the other end of the operating portion is bent to form a connecting section, and a bottom surface of the connecting section is formed with a pair of first through-holes and a pair of second through-holes.

5. The pot according to claim 4, wherein the cover-lifting mechanism comprises a pivoting portion inserted into the trough and the piston rod connected to the pivoting portion, the top surface of the pivoting portion is formed with a pivotal hole, and a pivot penetrates the pivotal hole and the first through-holes to pivotally connect the upper cover to the pivoting portion.

6. The pot according to claim 5, wherein one end of the piston rod is pivotally connected to the pivoting portion, and the other end of the piston rod is pivotally connected to the second through-holes of the connecting portion.

7. The pot according to claim 6, wherein a surface of the pivoting portion adjacent to the piston rod is formed with a notch for allowing the piston to extend obliquely therethrough.

8. The pot according to claim 7, wherein a distance is formed between the piston rod and the pivot, the piston rod is positioned closer to the rim of the pot body than the pivot, and a cover-lifting moment is generated by extension of the piston rod for pushing and lifting the upper cover completely.

9. A cover-lifting mechanism for a pot, the pot comprising a pot body and an upper cover for pivotally covering the pot body, the cover-lifting mechanism comprising a piston rod, both ends of the piston rod being pivotally connected to the pot body and the upper cover respectively, wherein the piston rod extends corresponding to an angle between the upper cover and the pot body when the upper cover is lifted.

10. The cover-lifting mechanism for a pot according to claim 9, wherein a distance is formed between the piston rod and a pivoting portion between the upper cover and the pot body, the piston rod is positioned closer to a rim of the pot body than the pivot, and a cover-lifting moment is generated by extension of the piston rod for pushing and lifting the upper cover completely.
